(19) United States
(12) Patent Application Publication
(10) Pub. No.: US 2020/0024170 A1
(43) Pub. Date: Jan. 23, 2020

(54) AEROBIC WASTEWATER TREATMENT SYSTEM

(71) Applicants: Marty Tittlebaum, Shepherdsville, KY (US); Grady Tucker, Brandon, MS (US)

(72) Inventors: Marty Tittlebaum, Shepherdsville, KY (US); Grady Tucker, Brandon, MS (US)

(21) Appl. No.: 16/224,263

(22) Filed: Dec. 18, 2018

Related U.S. Application Data
(63) Continuation-in-part of application No. 16/041,651, filed on Jul. 20, 2018.

(51) Int. Cl. C02F 3/12

(52) U.S. Cl. CPC C02F 3/1236; C02F 2001/007; C02F 2209/42

(57) ABSTRACT

A wastewater treatment system consisting of a single tank extended aeration activated sludge process with a continuously operating clarifier skimming device which is capable of producing a clear odorless effluent which meets applicable state discharge standards.

### CROSS REFERENCES TO RELATED APPLICATIONS

This application claims priority from U.S. application Ser. No. 16/041,651 filed on Jul. 20, 2018 and is incorporated herein in its entirety.

### TECHNICAL FIELD

The present invention relates to wastewater systems, and especially to those wastewater treatment systems which are packaged, containerized units.

### BACKGROUND OF THE INVENTION

Many new subdivisions are being developed on sewage collection and treatment processes utilizing on-site sewage treatment units. Many people build homes or place manufactured homes on lots not serviced by municipal sewage collection systems.

In the treatment of wastewater, there is often utilized a containerized or packaged unit treatment plant which treats received wastewater on an intermittent or small flow basis, such as from a home, small apartment building, or the like. In the home construction industry, for example, a buried, subsoil sewage treatment vessel or septic tank is often used for primary treatment of wastewater not serviced by municipal sewage collection systems. Such sewage treatment devices usually receive flow intermittently and at low hydraulic loading rates and must treat the intermittent flow to meet environmental and health standards. Oftentimes, the unit is merely a holding or “septic” tank that removes settleable solid waste from the wastewater stream.

There are two major problems with septic tanks. Septic tanks do not do a good job of treating the sewage. At best, they remove about 50% of the pollutants that are of concern for protecting the environment and almost none of the potentially disease-causing microorganisms. The second is that the partially treated sewage from septic tanks is discharged to the environment beneath the ground surface to a drain field. When the soil is in a condition that sub-surface discharge is not possible or allowed, pollution of the ground water or polluting surface waters can occur.

It is desirable that wastewater be treated in an economical way using as little energy as possible and as few moving parts as possible, while removing a high percentage of solid material from the wastewater stream, and while lowering the chemical oxygen demand (COD) and the biochemical oxygen demand (BOD) of the wastewater stream. It is desired that a minimum of sludge removal would be required since sludge disposal presents an extra problem.

Waste material entering the unit is heterogeneous in nature, containing solid waste material and liquid wastewater. It is desirable that a wastewater treatment apparatus produce a total homogenation of the fluids received from the waste stream to be properly biodegraded.

Aerated treatment units use air, blown into the sewage, to increase the growth of microorganisms. Those microorganisms, or “bugs”, use the harmful organic matter in our waste as a food source. This increased activity greatly reduces the harmful pollutants in the treated sewage. Those pollutants are generally reduced by approximately 85 to 95%. With the use of chlorination, harmful microorganisms can be all but totally eliminated. Another great advantage to aerated treatment units is that their treated effluent can be discharged in several different ways. Depending on local regulations and specific site conditions, the treated sewage from an aerated treatment unit may be discharged to a drain field, to a surface receiving stream, by overland flow on your property, into a mound system, by drip irrigation or by spray disposal.

In some aerated treatment systems, there is a problem of clogging of the aeration assembly, or diffuser, which provides oxygen and mixing to the unit. Such clogging will cause a degeneration of the treatment process or possibly a total stoppage of air flow to the vessel, converting the process conditions from aerobic to anaerobic, thus removing most of the treatment capability. Also, some aeration assemblies are prone to movement within the vessel, due to the particular design of the assembly and the flexibility of the piping used in construction. Movement of the aeration assembly is unwanted for two primary reasons. First, the upward flow of bubbles should be directly underneath the influent line so that all incoming wastewater will be immediately subject to aeration. Second, the upward flow of bubbles should be kept close to the influent wall of the vessel so that the desired circular flow is maintained. Moreover Therefore, it is desirable that an aeration unit or diffuser be provided that minimizes or prevents clogging by solid material entering the unit and by microbial mass produced by the unit, and also moves solid material away from the side wall adjacent the influent line.

Perhaps the most troublesome problems encountered by prior art systems, however, are those pertaining to the accumulation of scum or floating material near the effluent line. For example, the portion of the vessel serving as the clarifier often contains floating material which can escape the treatment system via the effluent line along with clarified liquid. Ideally, such solids should not remain in the clarifier portion at all, but should re-enter the aeration portion of the vessel for further biodegradation. One solution to the problem of effluent solids, as disclosed in U.S. Pat. No. 4,834,879, has been to draw the effluent from below the surface of the liquid, and then directing the effluent through multiple turns in an effort to leave as much suspended solids within the vessel. While that device did serve to reduce the solids within the effluent more effectively than its predecessors, environmental laws are becoming increasingly more strict, requiring even further reductions in the amount of solids leaving such treatment systems.

Therefore, there is still a strong need for an innovative wastewater treatment system which: (1) increases the time that settleable solids spend within the aeration section of the treatment vessel, (2) decreases the amount of solids leaving the treatment vessel, and (3) remains as inexpensive and reliable as comparative systems.

Applicants prior U.S. Pat. No. 5,895,566 which issued on Apr. 20, 1999 and U.S. Pat. No. 6,099,722 which issued on Aug. 8, 2000, both of which are incorporated by reference herein in their entirety teach a self-contained wastewater treatment system. The present application further improves on the self-contained wastewater treatment system providing a more user friendly system requiring less maintenance.

### SUMMARY OF THE INVENTION

The system consists of a single tank extended aeration activated sludge system which is capable of producing a clear odorless effluent which meets applicable state discharge standards. This system has been successfully tested and listed by GCT, LLC in accordance with NSF/ANSI Standard 40. Raw wastewater flows into the aeration zone of the extended aeration system. Here, the oxygen supplied by the aeration system, along with the organic matter in the waste stream, creates an ideal environment for the growth of aerobic micro-organisms. These organisms convert the waste organic materials into gases and additional micro-organism cell material. In addition to supplying oxygen, the aeration system keeps the contents of the aeration zone well mixed to provide optimum exposure to the microorganisms to the waste material. The action of the beneficial microorganisms also result in a significant reduction in pathogenic bacteria. After approximately 24 hours of detection in the aeration zone, the mixture enters the clarifier where quiescent conditions enable separation of the micro-organisms which are returned to the aeration zone and discharge of clear treated wastewater through the launder assembly. At the surface of the clarifier there is a skimmer which removes any floating solids and returns them to the aeration zone automatically, while not disturbing the quiescent conditions of the clarifier. Effluent may be discharged to an accepted discharge point that is in compliance with all state and local laws and regulations.

The wastewater treatment system exceeds all effluent water quality requirements for Class 1 designation (25 mg/L CBODS and 30 mg/LTSS) as set forth by NSF/ANSI Standard 40. The six month daily average for the system is 7 mg/L CBODS and mg/L TSS.

The wastewater treatment system of the present invention is an economical alternative for use in treating domestic wastewater generated by normal household activities. The system consists of a single tank extended aeration activated sludge system which is capable of producing a clear odorless effluent which meets applicable state discharge standards. This system has been successfully tested and listed by NSF International in accordance with NSF/ANSI Standard 40.

Raw wastewater flows into the aeration zone of the extended aeration system. Here, the oxygen supplied by the aeration system, along with the organic matter in the waste stream, creates an ideal environment for the growth of aerobic micro-organisms. These organisms convert the waste organic materials into gases and additional micro-organism cell material. In addition to supplying oxygen, the aeration system keeps the contents of the aeration zone well mixed to provide optimum exposure to the micro-organisms to the waste material. The actions of the beneficial micro-organisms also result in a significant reduction in pathogenic bacteria.

After approximately 24 hours of detention in the aeration zone, the mixture enters the clarifier where quiescent conditions enable separation of the micro-organisms. The settled micro-organisms are returned to the aeration zone and the clear, treated wastewater is discharged through the launder assembly. At the surface of the clarifier there is a skimmer assembly which removes floating solids and returns them to the aeration zone automatically, while not disturbing the quiescent conditions of the clarifier. Effluent may be discharged to an accepted discharge point that is in compliance with all state and local laws and regulations.

A self-contained wastewater treatment system is provided, comprising a vessel having a bottom, side walls and a lid defining a hollow interior for containing wastewater, the vessel being adapted for installation underground; an influent line; an effluent line; and a baffle disposed within the interior, generally between the influent line and the effluent line and extending transversely toward opposing side walls of the vessel. The baffle includes a bottom edge separated by a predetermined distance from the bottom of the vessel to define a flow opening. The position of the baffle defines an upstream aeration chamber and a downstream clarifier chamber within the vessel. The side walls include a downstream end wall, the downstream end wall having a lower inclined wall which intersects the bottom of the vessel adjacent the flow opening. Also included are aeration means for producing aeration within the aeration chamber, positioned to produce a generally circular flow path within the aeration chamber, the circular flow path having a flow path component adjacent the flow opening with a flow direction generally away from the clarifier chamber. The design of the aeration chamber of the vessel provides a solids removal means operatively disposed between the aeration chamber and the clarifier chamber for drawing solids in the wastewater within the clarifier chamber and transferring the solids back into the aeration chamber.

A self-contained wastewater treatment system is provided, comprising a vessel having a bottom, side walls and a lid defining a hollow interior for containing wastewater, the vessel being adapted for installation underground; an influent line positioned at a first upper portion of the vessel for transferring a wastewater stream to the vessel; an effluent line positioned at a second upper portion of the vessel generally opposite the influent line for discharging treated wastewater from the vessel; a baffle disposed within the interior, generally between the influent line and the effluent line and extending transversely toward opposing side walls of the vessel. The baffle also extends upwardly toward the lid and above an operating water surface elevation within the vessel, wherein the baffle includes a bottom edge separated by a predetermined distance from the bottom of the vessel to define a flow opening. The position of the baffle defines an upstream aeration chamber and a downstream clarifier chamber within the vessel. The side walls include a downstream end wall, the downstream end wall having a lower inclined wall which intersects the bottom of the vessel adjacent the flow opening. Also included are aeration means for producing aeration within the aeration chamber, positioned to produce a generally circular flow path within the aeration chamber, the circular flow path having a flow path component adjacent the flow opening with a flow direction generally away from the clarifier chamber. The vessel also includes solids removal means operatively disposed between the aeration chamber and the clarifier chamber for drawing solids in the wastewater within the clarifier chamber and transferring the solids into the aeration chamber.

In a more specific embodiment, the solids removal means comprises a generally U-shaped tube having a suction portion extending into the clarifier chamber and a discharge portion extending into the aeration chamber, and further including a solids removal air line in fluid communication with the discharge portion wherein air is passed into the discharge portion to create a suction within the suction portion sufficient to collect solids located in the clarifier chamber and transfer the solids to the aeration chamber.

Preferably, the aeration means comprises an air diffuser formed into a horizontal, rectangularly shaped conduit, cylinder, or plate having a plurality of air discharge holes formed therein. In order to prevent clogging of the air exit holes, the holes are preferably formed on the sides of the conduit.

Optionally, a float switch is included within the vessel for activating an alarm during a predetermined high water level within the vessel.

The wastewater treatment system may further comprise laundering means adjacent and in fluid communication with the effluent line for preventing solids from exiting through the effluent line. In a preferred embodiment, the laundering means includes an effluent outlet assembly of a down turned 90 degree elbow conduit having a first and second end, wherein the first end is defines a horizontal conduit portion sealably attached to the vessel wall positioned with a top portion above the water line and bottom portion below the water line. The second end defines a vertical conduit portion having a distal end disposed below the water line. At least one and preferably a plurality of apertures or holes are formed or drilled in a tube, pipe or other conduit whereby the volume of fluid which is determined by the number and size of the holes. Preferably the hole size is utilized to control water exit velocity resulting in a laundering means for preventing solids from exiting through the effluent line.

It is an object of the present invention to provide an aerobic wastewater treatment system with no internal moving parts to decrease maintenance costs

It is an object of the present invention to include ground level access ports for inspection.

It is an object of the present invention to maintain a rebound rate of 24 hours or less whereby the entire system returns to optimal operating conditions after experiencing a heavy “shock load” such as the introduction of chemicals from a full day of household cleaning.

It is therefore an object of this invention to provide a wastewater treatment system which maximizes the time that settleable solids spend within the aeration portion of the treatment vessel.

It is also an object of this invention to provide a wastewater treatment system which minimizes the amount of solids leaving the treatment vessel through the effluent line.

It is a further object of this invention to provide a wastewater treatment system which includes a superior diffuser assembly that ensures maintenance of the proper circulation within the aeration portion of the treatment vessel.

It is another object of the present invention to provide a flow restricting device comprising a restriction means such as a simple flat disc or washer having at least one aperture of a selected size for to allow a selected small amount of air from the compressor to flow through the flow restricting device continually without requiring a valve.

Yet another object of this invention is to provide a wastewater treatment system which is inexpensive and reliable with extremely low maintenance costs and requirements.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a top view of a preferred embodiment of the present invention;

FIG. 2 is a side view of a laundering means attaching to the effluent line;

FIG. 3 is an end view of the laundering means of FIG. 2;

FIG. 4 is a side elevation sectional view of the present invention shown in position buried beneath the surface of the ground;

FIG. 5 is a detailed sectional view of the skimmer assembly;

FIG. 6 is perspective view including a cut-away section showing the flow path of the system and the baffle and air diffuser within the aeration chamber; and

FIG. 7 shows an exploded view of a section of the conduit extending from the air compressor to the skimmer and the air flow restriction device comprising a washer having an aperture therein for insertion in the conduit; and

FIG. 8 shows an assembled view of the section of the conduit extending from the air compressor to the skimmer and the air flow restriction device of FIG. 7, wherein the washer having an aperture therein is inserted into the conduit.

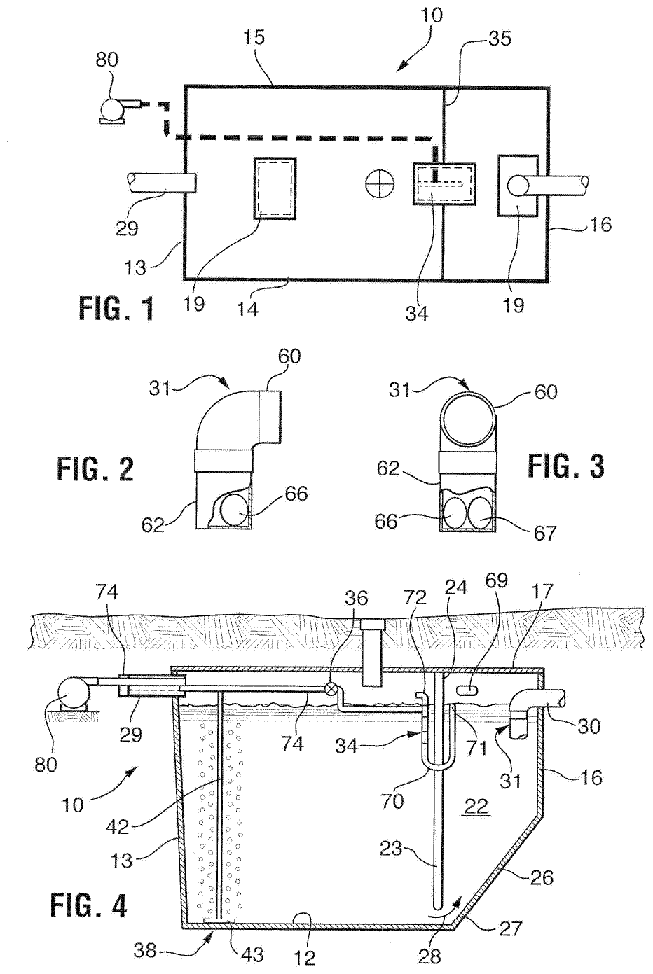

### DESCRIPTION OF THE PREFERRED EMBODIMENTS

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “about” can be reasonably appreciated by a person skilled in the art to denote somewhat above or somewhat below the stated numerical value, to within a range of ±10%.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The apparatus of the present invention, designated by numeral 10 in the drawings, includes a vessel 11 having a bottom 12 which is preferably rectangular and four upstanding vertical side walls 13-16 which are connected edge-to-edge. A lid 17 forms a sealed closure over the vessel 11 to define an interior 18 which can contain a fluid volume therein. Access hatch 19 allows periodic inspection of the unit for purposes of repair and/or maintenance and vent 33 extends above the surface of the ground.

The interior 18 of the vessel 11 comprises a pair of separate chambers including an aeration chamber 21 and a clarifier chamber 22. The aeration chamber 21 and clarifier chamber 22 are defined and separated by an upstanding vertical and transversely extending baffle 23 which is preferably connected at its upper edge 24 to lid 17. The bottom 25 of the baffle 23 is positioned near the bottom 12 of the vessel 11, but does not touch the bottom 12. Baffle 23 preferably forms a continuous seal and connection with side walls 14 and 15 so that fluid can only flow from one end of vessel 11 to the other under baffle 23 and more particularly under the bottom edge 25 thereof.

Downstream of baffle 23 is an inclined wall 26 which is connected to the bottom 12 of vessel 11 and also to side wall 16. An opening 28 defines a flow zone from aeration chamber 21 and into clarifier 22. Flow opening 28 thus is the relatively small area defined by bottom 25 of baffle 23, and by side walls 14 and 15 and by the bottom 27 of inclined wall 26.

By positioning the bottom inclined wall 26 adjacent the bottom 25 of baffle 23, a small flow zone is produced. Also, the inclined wall 26 is inclined sufficiently so that solid material cannot collect upon it. A suitable inclination for wall 26 would be at least fifty-three degrees (53 degrees) from horizontal. Thus, any solid matter which might flow through flow opening 28 and into clarifier 22 will settle upon inclined wall 26 and slide downwardly until it reaches the bottom 27 of inclined wall 26. This places any solid material which might enter clarifier 22 back adjacent flow opening 28 so that turbulence is created in aeration chamber 21 by diffuser assembly 38 can carry away suspended solid material form the mixed liquor back into aeration chamber 21. Arrows 45 illustrate a circular or rolling flow pattern within aeration chamber 21 which creates a flow path component at opening 28 away from clarifier 22. Notice that inclined wall 26 extends fully across vessel 11 between side walls 14 and 15 and from side wall 16 forwardly to bottom edge 27. Thus, any solid material over the entire horizontal cross-section of clarifier 22 will be channeled back to flow opening 28.

Aeration chamber 21 contains a diffuser assembly 38 which is positioned generally under inlet 29 and at the bottom of vessel 11 adjacent side wall 13. Diffuser assembly 38 preferably includes one or more aspirations fluidically connected to an air line 42 extending upwardly and fluidically connected to air line 74 which extends through the lid 17 or side wall 13 and out of vessel 11. Air is pumped continuously through air line 74 and 42 by a single outlet compressor/blower 80 located at ground level above the vessel 11. The diffuser includes a plurality of side openings or apertures 43 spaced apart along the sides of the diffuser. It is important that side openings 43 be placed on the sides of the diffuser 38 as opposed to the top or bottom, so that air bubbles may exit laterally from the diffuser 38. Prior art diffuser assemblies suffered from frequent clogging of the openings by solids either falling into the openings on the tops of the conduit or closing such openings on the bottoms of the conduit by accumulation of solids at the bottom of the vessel 11. The diffuser minimizes the likelihood that settleable solids will clog the openings 43, thus ensuring greater aeration efficiency. Also, the diffuser assembly 38 resting on the bottom 12 of the vessel 11, prevents it from “walking” away from the side wall 13 during operation. This is a significant advantage over prior art diffusers, because undesirable movement of the diffuser causes an interruption and/or nonuniformity of the necessary continuous flow path 45 within the aeration chamber 21. In one preferred embodiment, approximately 99 percent of the air from the compressor exits through the diffuser 38 and about one percent of the air exits through conduit 74 which is reduced in diameter to about ½ inch diameter line and shown as conduit 75 in which an air flow restricting device 36 is inserted prior to the skimmer assembly 34. The amount of air flowing through the restricting device is preferably from 0.5 to 5.0%, more preferably from 0.5 to 2.0% and more preferably about 1%.

Wastewater enters the aeration chamber 21 through inlet pipe 29 and clarified supernatant liquid exits the clarifier 22 through a launder 31 to outlet pipe 30. As shown in more detail in FIGS. 2 and 3, he wastewater treatment system may further comprise laundering means adjacent the effluent line for preventing solids from exiting through the effluent line. In a preferred embodiment, the laundering means includes an effluent outlet assembly comprising a down turned 90 degree elbow conduit having a first and second end, wherein the first end 60 defines a horizontal conduit portion sealably attached to the vessel wall positioned with a top portion above the water line and bottom portion below the water line. The second end 62 defines a vertical conduit portion having a distal end disposed below the water line. At least one hole, a plurality of apertures or holes, or more preferably a pair of holes are formed or drilled in a tube, pipe or other conduit whereby the volume of fluid is determined by the size of the holes. Preferably the hole size is utilized to control water exit velocity resulting in a laundering means 66 and 67 for preventing solids from exiting through the effluent line. The down turned conduits having openings therein provide sufficient surface area for efficient discharge and replaces the weir type device in the prior art devices while allowing more control of the velocity of the fluid for better clarifier results.

Notably, the effluent line 30 is at the same height, which is approximately equal to the height of liquid within vessel 11 under normal operating conditions. Much of the solids that might exist in clarifier 22 are laundered away from the effluent line 30. It should be understood that the launder 31, as specifically disclosed herein, may be effected in a multitude of ways not employing pipes. For example, any structural arrangement which establishes a single quiescent zone prior to passing of the liquid over a weir would be functionally equivalent.

A skimmer assembly 34, or solids removal means, is shown for the purposes of transferring solids from the clarifier 22 back into the aeration chamber 21. Conveniently, the skimmer 34 acts as an air lift pump and may be powered by the same air compressor/blower 80 that operates the diffuser assembly 38, as will be explained in further detail below.

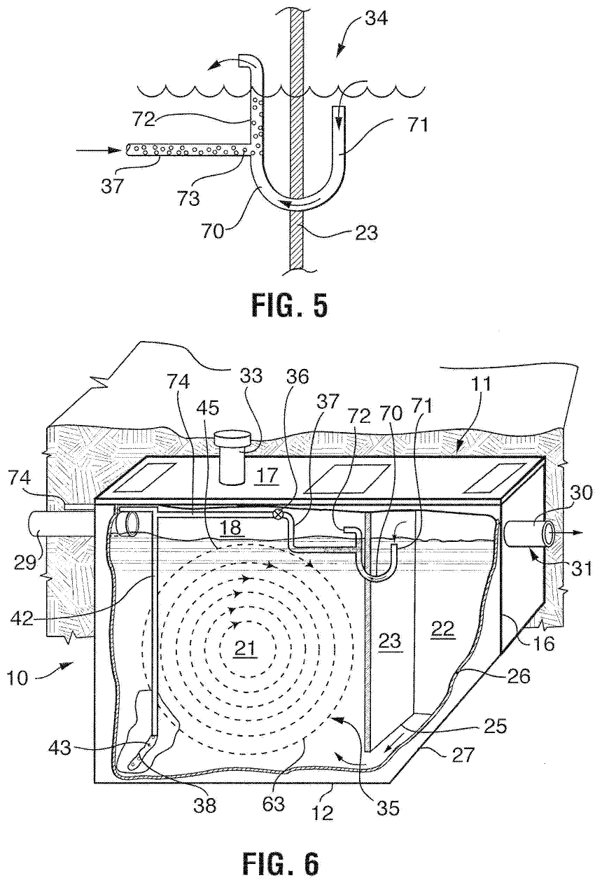

Referring specifically to FIG. 5, the skimmer 34 is constructed from a generally U-shaped pipe 70 which is attached across the baffle 23, wherein the U-shaped pipe 70 includes a suction portion 71 whose terminal end is positioned immediately below the normal operating liquid level within the clarifier 22, as well as a discharge portion 72 whose terminal end is positioned above the normal operating liquid level within the aeration chamber 21. In a preferred embodiment, an air line 74 is fluidically connected on one end 73 to the discharge portion 72 of the skimmer 34 below the liquid level in the aeration chamber 21.

Skimmer air line 37 extends across aeration chamber 21 and is fluid connection at its opposite end 74 to a air restricting device 36 which is in turn in fluid connection to the diffuser air line 42 which are supplied air from a single outlet compressor/blower unit 80 in fluid communication therewith. The compressor/blower 80 is in turn fluidically connected to the diffuser and skimmer air line 74. The single outlet compressor/blower 80 provides the flow of air to the air flow restricting device 36 and then to the skimmer in order to control the vacuum created by the skimmer 34 which is operated to provide the requisite effective amount of air flow to remove floating solids from the clarifier 22 without significantly detracting from the aeration and turbulence created by the diffuser assembly 38.

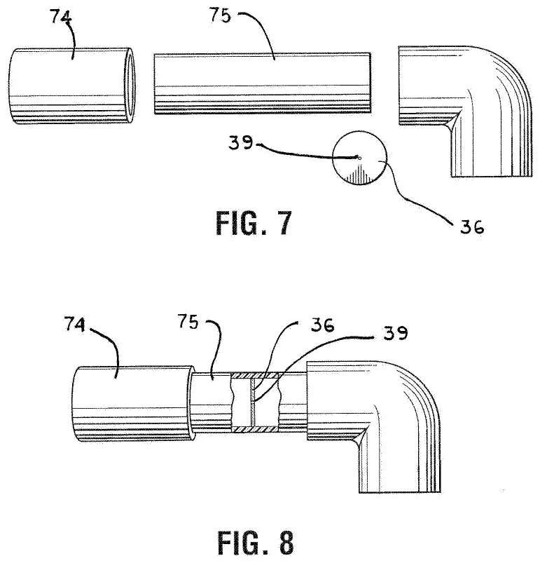

Under normal operating conditions and for most of the time, air from the external compressor/blower 80 travels through the air line 74 for operation of the diffuser assembly 38 air flow restricting device 36 and then subsequently to the skimmer 34. The flow restricting device 36 comprises restriction means such as a simple flat disc, blank, or washer having at least one aperture 39 of a selected size for to allow a selected small amount of air from the compressor to flow through the flow restricting device 36 continually without requiring a valve as best illustrated in FIGS. 7 and 8. It is contemplated that a valve, section of conduit having a reduced air flow or other means can be used to restrict the air flow to a selected rate and/or volume; however, the present system does not require opening and closing or adjustment of the valve to operate continuously. The rate of air flow can be selected by simply choosing a washer having an aperture of a different size, increasing the number of apertures or increasing the pressure of the air flow from the compressor. Air bubbles exiting the end 73 of the skimmer travel upward through the discharge portion 72 of the skimmer 34, which forces liquid within the U-shaped pipe 70 to move from the clarifier 22 into the aeration chamber 21. The suction created near the surface of the clarifier 22 cause any floating solids to be sucked into the skimmer 34 and deposited back into the aeration chamber 21. By way of example, skimmer 34 is operated at a selected air flow rate. The continuous skimming operation performed continually drastically reduces the solids present in the clarifier 22, forcing those solids to be further biodegraded.

Optionally, an alarm system can be implemented to detect flooding conditions within the vessel 11 or a loss of power to the compressor/blower assembly 80. As shown in figures, a normally closed float switch 69 is affixed within the clarifier 22 just above the normal liquid level. The float switch 69 is connected to the alarm circuitry by a normally open float. When the float switch 69 rises, indicating a high water level, the normally open switch closes and activates the alarm circuitry indicating a high water condition. The alarm may be any audible and/or visual indication that a high water condition is present. The activation of alarm also occurs in the event that power is interrupted to the transformer.

Thus, the apparatus of the present invention is a paragon of simplicity, yet has been found to be highly efficient in the treatment of wastewater, and superior in terms of minimizing effluent solids in comparison to prior art systems. It is believed that the use of the laundering means 31 even without the use of the skimmer 34, provide significant advantages in treatment efficiency over the prior art. Likewise, it is believed that the use of the skimmer 34, even without the use of the laundering means 31, provides similar advantages. Therefore, the scope of the present invention should not be viewed as being limited to having each and every one of the aforementioned components. Rather, the invention affords the user to include some or all of the novel features discussed herein to achieve varying ranges of treatment efficiency depending upon resources and the need to comply with any applicable environmental and/or health regulations.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A self-contained wastewater treatment system with a continuously operating clarifier skimming device, comprises:
(a) a vessel having a bottom, side walls and a lid defining a hollow interior for containing wastewater, said vessel being adapted for installation underground;
(b) an influent line positioned at a first upper portion of said vessel for transferring a wastewater stream to said vessel;
c) an effluent line positioned at a second upper portion of said vessel generally opposite said influent line for discharging treated wastewater from said vessel;
(d) a baffle disposed within said interior, generally between said influent line and said effluent line and extending transversely toward opposing side walls of said vessel, said baffle extending upwardly toward said lid and above an operating water surface elevation within said vessel, wherein said baffle includes a bottom edge separated by a predetermined distance from said bottom of said vessel to define a flow opening, and wherein said baffle defines an upstream aeration chamber and a downstream clarifier chamber within said vessel;
(e) said side walls including a downstream end wall, said downstream end wall having a lower inclined wall which intersects said bottom of said vessel adjacent said flow opening;
(f) aeration means for producing aeration within said aeration chamber, positioned to produce a generally circular flow path within said aeration chamber, said circular flow path having a flow path component adjacent said flow opening with a flow direction generally away from said clarifier chamber;
(g) solids removal means operatively disposed between said aeration chamber and said clarifier chamber for drawing solids in said wastewater within said clarifier chamber and transferring said solids into said aeration chamber;
(h) means for producing a selected volume of air at a continuous flow rate in fluid communication with said aeration means and a skimmer; and
(I) laundering means adjacent to and in fluid communication with an effluent line preventing solids from exiting through said effluent line said laundering means adjacent and in fluid communication with the effluent line for preventing solids from exiting through the effluent line, wherein an effluent outlet assembly comprises an effluent outlet assembly including a down turned 90 degree elbow conduit having a first and second end, wherein said first end defining a horizontal conduit portion sealably attached to a vessel wall positioned with a top portion extending above a water line and a bottom portion extending below said water line, and said second end defining a vertical conduit portion having a distal end disposed below said water line including at least one opening therein sized for controlling the exit velocity of said water preventing solids from exiting through the effluent line.

2. The self-contained wastewater treatment system with a continuously operating clarifier skimming device of claim 1 wherein said means for producing a selected volume of air at a continuous flow rate in fluid communication with said aeration means and a skimmer comprises a restriction means comprising a simple flat disc having at least one aperture of a selected size there through allowing a selected small amount of air from the compressor to flow through the flow restricting device continually without requiring a valve.

3. The self-contained wastewater treatment system with a continuously operating clarifier skimming device of claim 1, wherein said solids removal means is a skimmer comprising a generally U-shaped tube having a suction portion extending into said clarifier chamber and a discharge portion extending into said aeration chamber, and further including a solids removal air line in fluid communication with said discharge portion wherein air is passed into said discharge portion to create a suction within said suction portion sufficient to collect solids located in said clarifier chamber and transfer said solids to said aeration chamber.

4. The self-contained wastewater treatment system with a continuously operating clarifier skimming device of claim 1 self-contained wastewater treatment system with a continuously operating clarifier skimming device, wherein said baffle includes side edges forming a continuous seal with said opposing side walls.

5. The self-contained wastewater treatment system with a continuously operating clarifier skimming device of claim 1, wherein said aeration means comprises an air diffuser formed into a horizontal conduit having a plurality of air exit holes formed therein.

6. The self-contained wastewater treatment system with a continuously operating clarifier skimming device according to claim 1, further comprising a float switch within said vessel for activating an alarm during a predetermined high water level within said vessel.

7. The self-contained wastewater treatment system with a continuously operating clarifier skimming device of claim 1, wherein said second end defining a vertical conduit portion having a distal end disposed below said water line includes a plurality of drilled holes forming openings sized for controlling the exit velocity of said water preventing solids from exiting through the effluent line.

8. The self-contained wastewater treatment system with a continuously operating clarifier skimming device of claim 2 wherein the volume of air flowing through said air flow restricting device to said skimmer assembly is from about 0.5% to 5.0% of the total volume of air produced by the compressor.

9. The self-contained wastewater treatment system with a continuously operating clarifier skimming device of claim 2 wherein the volume of air flowing through said air flow restricting device to said skimmer assembly is from about 0.5% to 2.0% of the total volume of air produced by the compressor.

10. The self-contained wastewater treatment system with a continuously operating clarifier skimming device of claim 2 wherein the volume of air flowing through said air flow restricting device to said skimmer assembly is about 1% of the total volume of air produced by the compressor.

11. A self-contained wastewater treatment system with a continuously operating clarifier skimming device, consisting of:
(a) a vessel having a bottom, side walls and a lid defining a hollow interior for containing wastewater, said vessel being adapted for installation underground;
(b) an influent line positioned at a first upper portion of said vessel for transferring a wastewater stream to said vessel;
c) an effluent line positioned at a second upper portion of said vessel generally opposite said influent line for discharging treated wastewater from said vessel;
(d) a baffle disposed within said interior, generally between said influent line and said effluent line and extending transversely toward opposing side walls of said vessel, said baffle extending upwardly toward said lid and above an operating water surface elevation within said vessel, wherein said baffle includes a bottom edge separated by a predetermined distance from said bottom of said vessel to define a flow opening, and wherein said baffle defines an upstream aeration chamber and a downstream clarifier chamber within said vessel;
(e) said side walls including a downstream end wall, said downstream end wall having a lower inclined wall which intersects said bottom of said vessel adjacent said flow opening;
(f) aeration means for producing aeration within said aeration chamber, positioned to produce a generally circular flow path within said aeration chamber, said circular flow path having a flow path component adjacent said flow opening with a flow direction generally away from said clarifier chamber;
(g) solids removal means operatively disposed between said aeration chamber and said clarifier chamber for drawing solids in said wastewater within said clarifier chamber and transferring said solids into said aeration chamber;
(h) restrictive means for producing a selected volume of air at a continuous flow rate in fluid communication with said aeration means and a skimmer comprising a disc having at least one aperture of a selected size there through allowing a selected amount of air from the compressor to flow through the flow restricting device continually without requiring a valve; and
(I) laundering means adjacent to and in fluid communication with an effluent line preventing solids from exiting through said effluent line said laundering means adjacent and in fluid communication with the effluent line for preventing solids from exiting through the effluent line, wherein an effluent outlet assembly comprises an effluent outlet assembly including a down turned 90 degree elbow conduit having a first and second end, wherein said first end defining a horizontal conduit portion sealably attached to a vessel wall positioned with a top portion extending above a water line and a bottom portion extending below said water line, and said second end defining a vertical conduit portion having a distal end disposed below said water line including at least one opening therein sized for controlling the exit velocity of said water preventing solids from exiting through the effluent line.

12. The self-contained wastewater treatment system with a continuously operating clarifier skimming device of claim 11, wherein said solids removal means is a skimmer comprising a generally U-shaped tube having a suction portion extending into said clarifier chamber and a discharge portion extending into said aeration chamber, and further including a solids removal air line in fluid communication with said discharge portion wherein air is passed into said discharge portion to create a suction within said suction portion sufficient to collect solids located in said clarifier chamber and transfer said solids to said aeration chamber.

13. The self-contained wastewater treatment system with a continuously operating clarifier skimming device of claim 11 self-contained wastewater treatment system with a continuously operating clarifier skimming device, wherein said baffle includes side edges forming a continuous seal with said opposing side walls.

14. The self-contained wastewater treatment system with a continuously operating clarifier skimming device of claim 11, wherein said aeration means comprises an air diffuser formed into a horizontal conduit having a plurality of air exit holes formed therein.

15. The self-contained wastewater treatment system with a continuously operating clarifier skimming device according to claim 11, further comprising a float switch within said vessel for activating an alarm during a predetermined high water level within said vessel.

16. The self-contained wastewater treatment system with a continuously operating clarifier skimming device of claim 11, wherein said second end defining a vertical conduit portion having a distal end disposed below said water line includes a plurality of drilled holes forming openings sized for controlling the exit velocity of said water preventing solids from exiting through the effluent line.

17. The self-contained wastewater treatment system with a continuously operating clarifier skimming device of claim 11 wherein the volume of air flowing through said air flow restricting device to said skimmer assembly is from about 0.5% to 5.0% of the total volume of air produced by the compressor.

18. The self-contained wastewater treatment system with a continuously operating clarifier skimming device of claim 11 wherein the volume of air flowing through said air flow restricting device to said skimmer assembly is from about 0.5% to 2.0% of the total volume of air produced by the compressor.

19. The self-contained wastewater treatment system with a continuously operating clarifier skimming device of claim 11 wherein the volume of air flowing through said air flow restricting device to said skimmer assembly is about 1% of the total volume of air produced by the compressor.
